(19) United States
(12) Patent Application Publication
(10) Pub. No.: US 2007/0297059 A1
(43) Pub. Date: Dec. 27, 2007

(54) Light regulating board for sun visor

(75) Inventors: Kun-Hsiang Chen, Huwei Township (TW); Li-Chi Chang, Huwei Township (TW)

Correspondence Address: KAMRATH & ASSOCIATES P.A., 4825 OLSON MEMORIAL HIGHWAY, SUITE 245, GOLDEN VALLEY, MN, 55422, US

(73) Assignees: Chian Lung Technology Co., Ltd., Huwei Township (TW); Prozca Technology Co., Ltd., Huwei Township (TW)

(21) Appl. No.: 11/474,807

(22) Filed: Jun. 26, 2006

(51) Int. Cl. G02B 27/00

(52) U.S. Cl. 359/601; 359/613

(57) ABSTRACT

A light regulating board includes base plate, and two opaque layers mounted on two opposite side faces of the base plate and each having a plurality of light permeable zones. Thus, the light regulating board is mounted in a car to isolate the light from the light source provide a sunshade effect to a driver. In addition, the base plate of the light regulating board has an adjustable angle to adjust the light permeable width of the light permeable zones of each of the opaque layers so as to regulate the light permeability of the light regulating board.

### BACKGROUND OF THE INVENTION

1. Field of the Invention

The present invention relates to a light regulating board and, more particularly, to a light regulating board for a sun visor.

2. Description of the Related Art

A conventional sun visor is mounted in the top of a car body and can be pivoted downward to provide a sunshade effect to the driver in the car. However, the sun visor easily hinder the viewing lines of the driver's eyes, thereby causing inconvenience to the driver. A conventional light permeable board for a sun visor comprises a translucent colorful acrylic plate to provide a sunshade effect to the driver in the car. However, the light permeability of the colorful acrylic plate is fixed and cannot regulated, thereby limiting the versatility of the light permeable board. Another conventional light permeable board for a sun visor comprises a plurality of translucent colorful acrylic plates to provide a sunshade effect to the driver in the car. However, the light permeable board needs to provide a plurality of translucent colorful acrylic plates, so that the light permeable board has a larger volume and has an expensive price.

### BRIEF SUMMARY OF THE INVENTION

In accordance with the present invention, there is provided a light regulating board, comprising a base plate, and two opaque layers mounted on two opposite side faces of the base plate and each having a plurality of light permeable zones.

The primary objective of the present invention is to provide a light regulating board, wherein the light regulating board is mounted in a car to isolate the light from the light source provide a sunshade effect to a driver.

Another objective of the present invention is to provide a light regulating board, wherein the base plate of the light regulating board has an adjustable angle to adjust the light permeable width of the light permeable zones of each of the opaque layers so as to regulate the light permeability of the light regulating board.

A further objective of the present invention is to provide a light regulating board, wherein the light regulating board is expanded and located in front of the driver, the viewing lines of the driver's eye pass through the light permeable zones of each of the opaque layers, so that the light regulating board allows the driver seeing forward without obstructing the viewing lines of the driver's eye.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a light regulating board in accordance with the preferred embodiment of the present invention.

FIG. 2 is a partially side plan cross-sectional view of the light regulating board as shown in FIG. 1.

FIG. 3 is a schematic plan operational view showing use of the light regulating board as shown in FIG. 1.

FIG. 4 is a partially enlarged plan cross-sectional view of the light regulating board as shown in FIG. 3.

FIG. 5 is a locally enlarged view of the light regulating board as shown in FIG. 4.

FIG. 6 is a schematic operational view of the light regulating board as shown in FIG. 4.

FIG. 7 is a locally enlarged view of the light regulating board as shown in FIG. 6.

FIG. 8 is a perspective view of a light regulating board in accordance with another preferred embodiment of the present invention.

FIG. 9 is a partially side plan cross-sectional view of a light regulating board in accordance with another preferred embodiment of the present invention.

FIG. 10 is a schematic operational view of the light regulating board as shown in FIG. 9.

FIG. 11 is a perspective view of a light regulating board in accordance with another preferred embodiment of the present invention.

FIG. 12 is an exploded perspective view of a light regulating board in accordance with another preferred embodiment of the present invention.

### DETAILED DESCRIPTION OF THE INVENTION

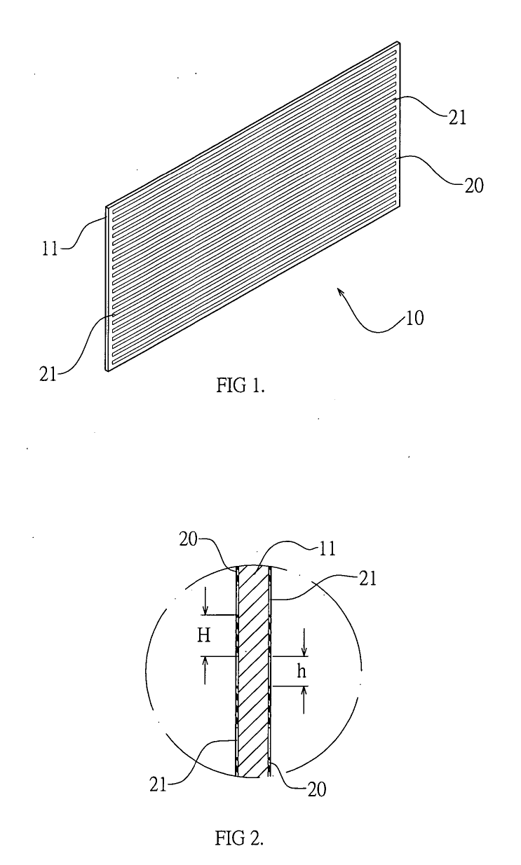

Referring to the drawings and initially to FIGS. 1 and 2, a light regulating board 10 in accordance with the preferred embodiment of the present invention comprises a base plate 11, and two opaque layers 20 mounted on two opposite side faces of the base plate 11 and each having a plurality of light permeable zones 21.

The base plate 11 is made of a transparent material or a colored material that can filter the light. Each of the opaque layers 20 is a thin film layer that is bonded onto each of the two opposite side faces of the base plate 11 by printing. Each of the light permeable zones 21 of each of the opaque layers 20 is an elongated transverse strip. Each of the light permeable zones 21 of each of the opaque layers 20 has a longitudinal height “h” equal or smaller than the thickness of the base plate 11, and an interval “H” between any two adjacent light permeable zones 21 of each of the opaque layers 20 is greater than a half of the thickness of the base plate 11. Preferably, the light permeable zones 21 at the two opaque layers 20 are aligned with each other in a symmetric manner as shown in FIG. 2.

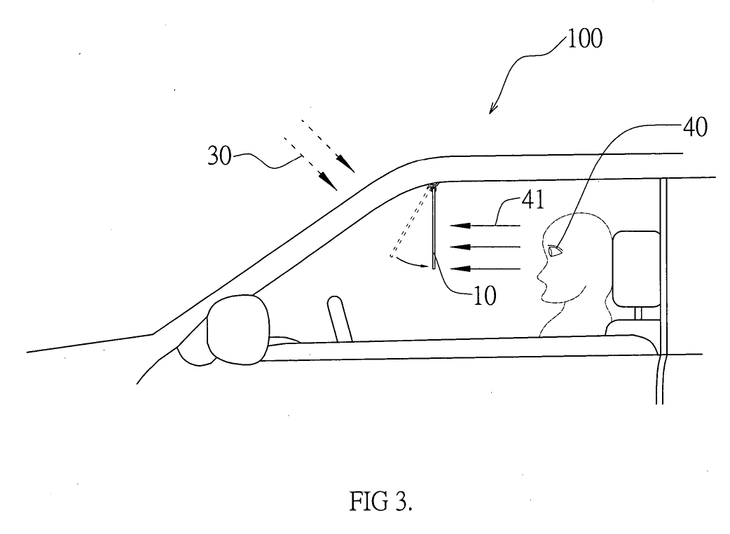

As shown in FIG. 3, the light regulating board 10 is mounted in a car 100 to isolate the light from the light source 30 provide a sunshade effect to a driver. At this time, the base plate 11 of the light regulating board 10 has an adjustable angle to isolate the light from the light source 30.

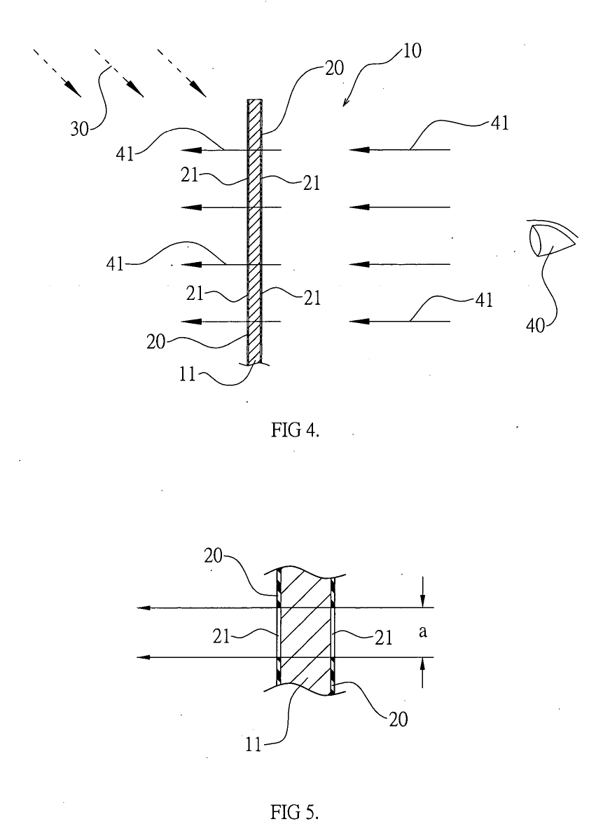

As shown in FIG. 4, the base plate 11 is located at a vertical state, so that each of the opaque layers 20 is located at a vertical state to isolate the light from the light source 30. At this time, when each of the opaque layers 20 is perpendicular with the viewing lines 41 of the driver's one eye 40, the viewing lines 41 of the driver's eye 40 pass through the light permeable zones 21 of each of the opaque layers 20, so that the light regulating board 10 allows the driver seeing forward without obstructing the viewing lines 41 of the driver's eye 40.

As shown in FIG. 5, the light permeable zones 21 of each of the opaque layers 20 have an adjustable light permeable width “a” which has a maximum value when the base plate 11 is located at a vertical state.

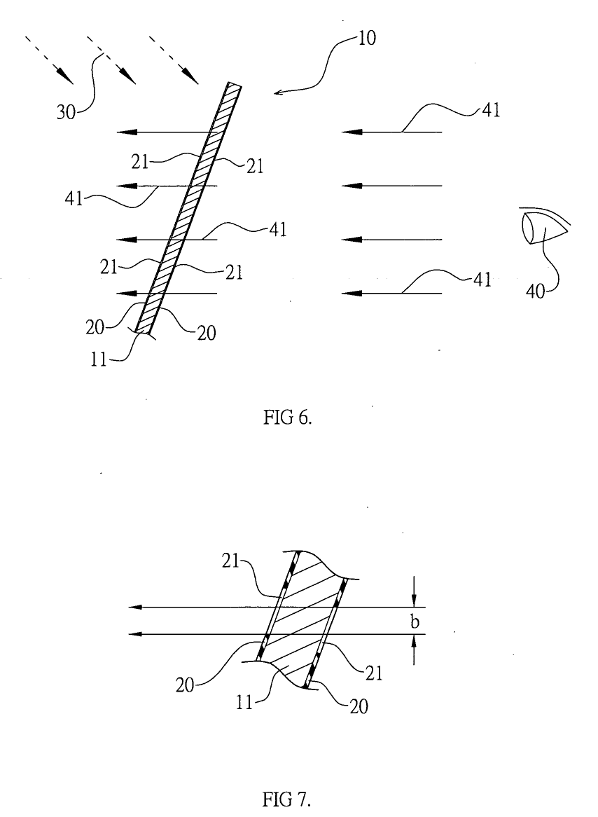

As shown in FIG. 6, the base plate 11 is located at an inclined state, so that each of the opaque layers 20 is located at an inclined state to isolate the light from the light source 30. At this time, when each of the opaque layers 20 is inclined with the viewing lines 41 of the driver's one eye 40, the viewing lines 41 of the driver's eye 40 also pass through the light permeable zones 21 of each of the opaque layers 20, so that the light regulating board 10 allows the driver seeing forward without obstructing the viewing lines 41 of the driver's eye 40.

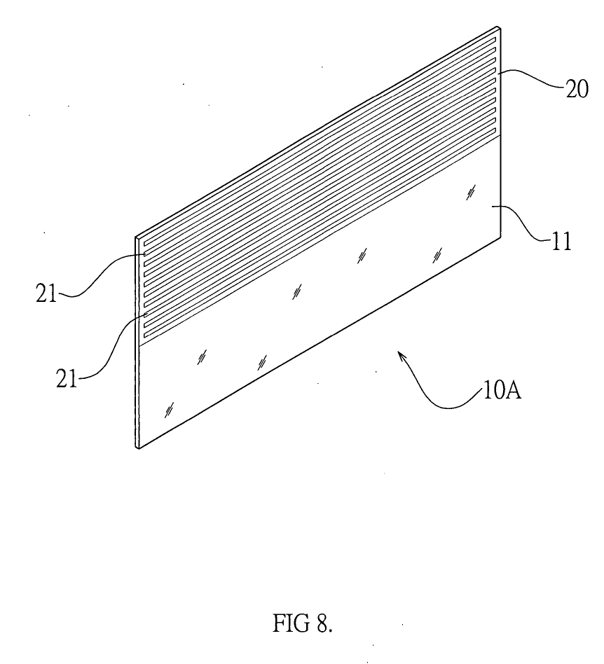

As shown in FIG. 7, when each of the opaque layers 20 is located at an inclined state, the light permeable zones 21 of each of the opaque layers 20 have a light permeable width “b” which is smaller than the maximum light permeable width “a”, so that the light permeability of the light regulating board 10 is reduced.

Thus, the base plate 11 of the light regulating board 10 has an adjustable angle to adjust the light permeable width of the light permeable zones 21 of each of the opaque layers 20 so as to regulate the light permeability of the light regulating board 10.

As shown in FIG. 8, each of the two opposite side faces of the base plate 11 of the light regulating board 10A has an upper portion provided with the respective opaque layer 20 and has a smooth lower portion.

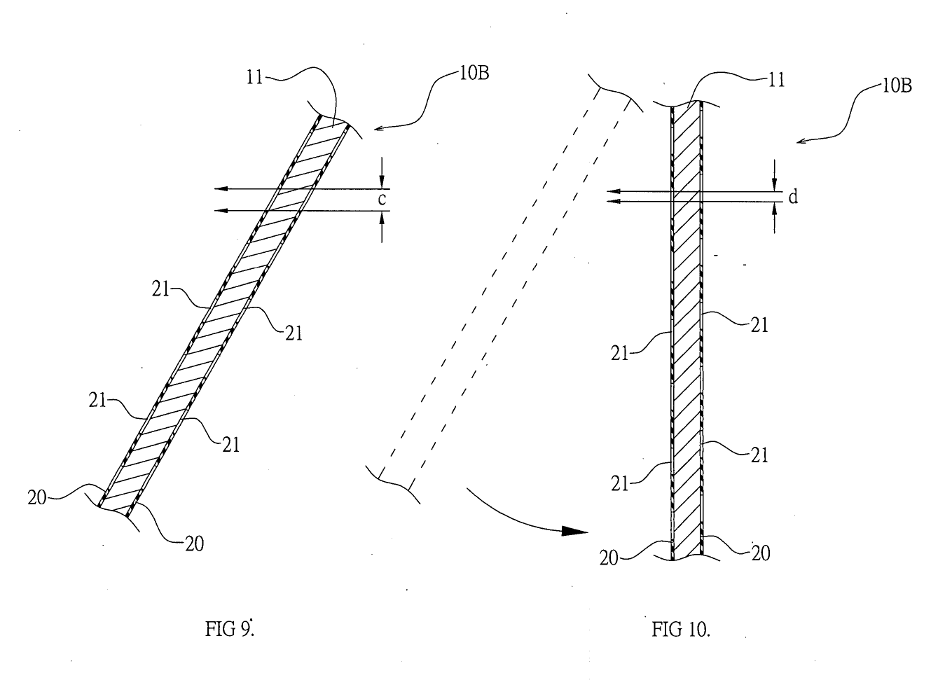

As shown in FIG. 9, the light permeable zones 21 at the two opaque layers 20 of the light regulating board 10B are arranged in a staggered manner so that the light permeable zones 21 at the two opaque layers 20 are not aligned with each other. At this time, the light permeable zones 21 of each of the opaque layers 20 have a greater light permeable width “c” when each of the opaque layers 20 is located at an inclined state.

As shown in FIG. 10, the light permeable zones 21 of each of the opaque layers 20 have a smaller light permeable width “d” when each of the opaque layers 20 is located at a vertical state.

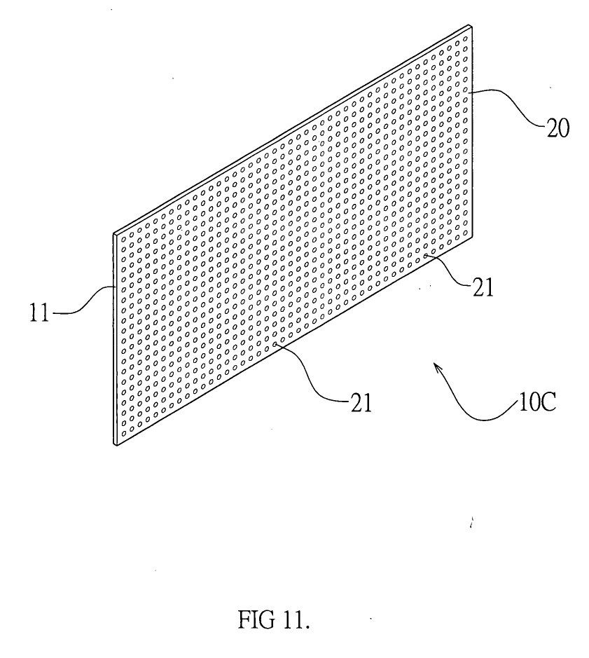

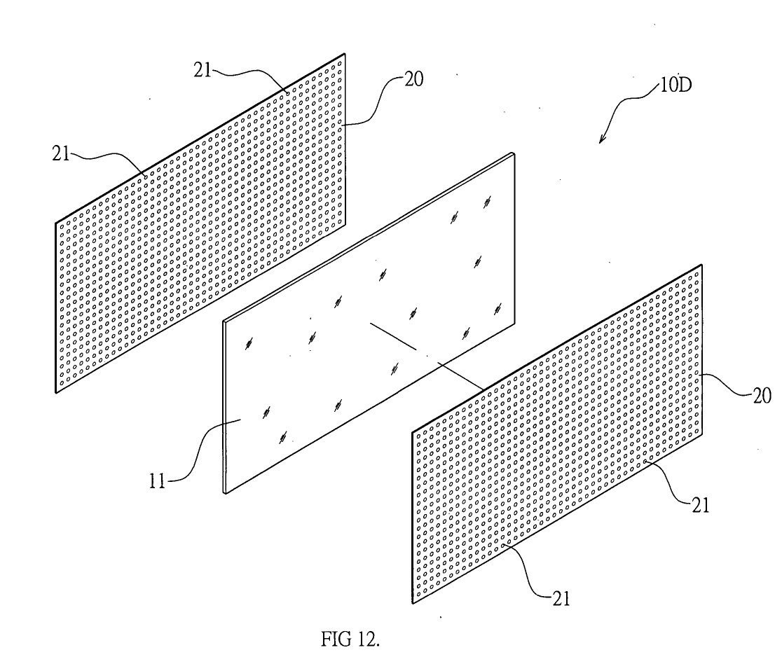

As shown in FIG. 11, each of the light permeable zones 21 of each of the opaque layers 20 of the light regulating board 10C has a circular shape. Alternatively, each of the light permeable zones 21 of each of the opaque layers 20 of the light regulating board 10C has a rectangular, tetragonal, oblong or semi-circular shape.

As shown in FIG. 12, each of the opaque layers 20 of the light regulating board 10D is bonded onto each of the two opposite side faces of the base plate 11 by adhesive.

Accordingly, the light regulating board 10 is mounted in a car 100 to isolate the light from the light source 30 provide a sunshade effect to a driver. In addition, the base plate 11 of the light regulating board 10 has an adjustable angle to adjust the light permeable width of the light permeable zones 21 of each of the opaque layers 20 so as to regulate the light permeability of the light regulating board 10. Further, the light regulating board 10 is expanded and located in front of the driver, the viewing lines 41 of the driver's eye 40 pass through the light permeable zones 21 of each of the opaque layers 20, so that the light regulating board 10 allows the driver seeing forward without obstructing the viewing lines 41 of the driver's eye 40.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A light regulating board, comprising:
a base plate;
two opaque layers mounted on two opposite side faces of the base plate and each having a plurality of light permeable zones.

2. The light regulating board in accordance with claim 1, wherein each of the light permeable zones of each of the opaque layers has a longitudinal height equal or smaller than the thickness of the base plate.

3. The light regulating board in accordance with claim 1, wherein an interval between any two adjacent light permeable zones of each of the opaque layers is greater than a half of the thickness of the base plate.

4. The light regulating board in accordance with claim 1, wherein the base plate has an adjustable angle to adjust a light permeable width of the light permeable zones of each of the opaque layers so as to regulate a light permeability of the light regulating board.

5. The light regulating board in accordance with claim 1, wherein each of the opaque layers is bonded onto each of the two opposite side faces of the base plate by printing.

6. The light regulating board in accordance with claim 1, wherein each of the light permeable zones of each of the opaque layers is an elongated transverse strip.

7. The light regulating board in accordance with claim 1, wherein the light permeable zones at the two opaque layers are aligned with each other in a symmetric manner.

8. The light regulating board in accordance with claim 1, wherein the light permeable zones of each of the opaque layers have an adjustable light permeable width.

9. The light regulating board in accordance with claim 1, wherein each of the two opposite side faces of the base plate of the light regulating board has an upper portion provided with the respective opaque layer.

10. The light regulating board in accordance with claim 1, wherein the each of the two opposite side faces of the base plate of the light regulating board has a smooth lower portion.

11. The light regulating board in accordance with claim 1, wherein the light permeable zones at the two opaque layers of the light regulating board are arranged in a staggered manner so that the light permeable zones at the two opaque layers are not aligned with each other.

12. The light regulating board in accordance with claim 1, wherein each of the light permeable zones of each of the opaque layers of the light regulating board has a circular shape.

13. The light regulating board in accordance with claim 1, wherein each of the light permeable zones of each of the opaque layers of the light regulating board has a rectangular shape.

14. The light regulating board in accordance with claim 1, wherein each of the light permeable zones of each of the opaque layers of the light regulating board has a tetragonal shape.

15. The light regulating board in accordance with claim 1, wherein each of the light permeable zones of each of the opaque layers of the light regulating board has an oblong shape.

16. The light regulating board in accordance with claim 1, wherein each of the light permeable zones of each of the opaque layers of the light regulating board has a semi-circular shape.

17. The light regulating board in accordance with claim 1, wherein each of the opaque layers of the light regulating board is bonded onto each of the two opposite side faces of the base plate by adhesive.

18. The light regulating board in accordance with claim 1, wherein the base plate is made of a transparent material, and each of the opaque layers is a thin film layer.
